(19) United States
(12) Patent Application Publication
(10) Pub. No.: US 2016/0315930 A1
(43) Pub. Date: Oct. 27, 2016

(54) CLOUD DATA DISCOVERY METHOD AND SYSTEM FOR PRIVATE INFORMATION PROTECTION AND DATA LOSS PREVENTION IN ENTERPRISE CLOUD SERVICE ENVIRONMENT

(71) Applicant: Somansa Co., Ltd., Seoul (KR)

(72) Inventors: Tae Wan KIM, Seoul (KR); Seung Tae PAEK, Seoul (KR)

(21) Appl. No.: 14/728,503

(22) Filed: Jun. 2, 2015

(30) Foreign Application Priority Data
Apr. 24, 2015 (KR) 10-2015-0058088

(51) Int. Cl. H04L 29/06; G06F 21/62

(52) U.S. Cl. CPC H04L 63/08; G06F 21/6218; H04L 63/10

(57) ABSTRACT

Provided is a cloud data discovery method which includes storing cloud application program interface (API) authentication information for each cloud service and accessing user data stored in a corresponding cloud service using the stored cloud API authentication information and checking the user data according to a preset data loss prevention (DLP) policy.

### CROSS-REFERENCE TO RELATED APPLICATION

This application claims priority to and the benefit of Korean Patent Application No. 10-2015-0058088, filed on Apr. 24, 2015, the disclosure of which is incorporated herein by reference in its entirety.

### FIELD

The present invention relates to a cloud data discovery method and system for private information protection and data loss prevention, and more particularly, to a cloud data discovery method and system in which it is checked whether significant information such as private information or classified information is included by accessing a document or file of a user stored in enterprise cloud services.

### BACKGROUND

Recently, according to the widespread introduction of cloud services in companies, security threats such as the exposure of classified information of a company or private information increase. Also, as a bring your own device (BYOD) environment accelerates, the theft of internal information of a company becomes a very serious problem and the needs of controlling data and improving data security increase. Accordingly, in companies which introduce cloud services, it is necessary to check and manage which user stores or shares which private information or classified information in clouds. This function described above is so-called data loss prevention (DLP) discover.

Enterprise cloud services generally provide a cloud application program interface (API) which may access cloud services as a representational state transfer (REST) API form. It is possible to access cloud services to perform DLP discover through cloud APIs. Also, for the authentication and authorization of cloud APIs, the OAuth standard is generally used.

In cloud services, to perform DLP discover, it is necessary to perform the authentication and authorization of cloud APIs to allow users to access data. However, authentication and authorization systems for allowing users using cloud services to access data may vary according to cloud services. For example, there are present (i) a method of accessing user data using one of the authentication of an administrator account and an OAuth access token of the administrator account, (ii) a method of accessing user data through authentication of a service account, and (iii) a method of accessing user data only using one of a corresponding user account and an OAuth access token of the user account.

In the cases of (i) and (ii), it is possible to easily access user data stored in cloud services using one of an administrator account and a service account through a cloud API. However, in the case of (iii), since it is necessary to know a user account, that is, a user ID and a password, it is actually difficult to perform a DLP discover function due to the revelation of the password.

### SUMMARY

An aspect of the present invention is to provide a cloud data discovery method and system capable of performing a data loss prevention (DLP) discover function with respect to user data stored in cloud services in response to an authentication and authorization system for allowing a user of enterprise cloud services to access data.

Another aspect of the present invention is to provide a cloud data discovery method and system capable of effectively performing a DLP discover function even in the case of enterprise cloud services in which it is possible to access user data only using one of a user account and an OAuth access token.

According to an aspect of the present invention, there is provided a cloud data discovery method including (a) storing cloud application program interface (API) authentication information for each cloud service and (b) accessing user data stored in a corresponding cloud service using the stored cloud API authentication information and checking the user data according to a preset DLP policy.

The operation (a) may include, in the case of a cloud service which allows accessing the user data through authentication of one of an administrator account and a service account, storing one of a corresponding administrator account, a corresponding service account, and an OAuth access token and a refresh token issued through the authentication of one of the corresponding administrator account and the corresponding service account from the corresponding cloud service, as the cloud API authentication information.

The operation (a) may include, in the case of a cloud service which does not allow accessing the user data through authentication of one of an administrator account and a service account, storing an OAuth access token and a refresh token issued through authentication of a user account from the corresponding cloud service, as the cloud API authentication information.

The operation (a) may further include being periodically reissued and storing the OAuth access token using the stored refresh token.

The operation (a) may further include, when the stored OAuth access token is invalid any OAuth access token is not stored, deactivating the corresponding user account or setting an access denial of the cloud service.

According to another aspect of the present invention, there is provided a cloud data discovery system including an authentication information administration unit which stores cloud API authentication information for each cloud service and a user data checking unit which accesses user data stored in a corresponding cloud service using the stored cloud API authentication information and checks the user data according to a preset DLP policy.

The authentication information administration unit, in the case of a cloud service which allows accessing the user data through authentication of one of an administrator account and a service account, may store one of a corresponding administrator account, a corresponding service account, and an OAuth access token and a refresh token issued through the authentication of one of the corresponding administrator account and the corresponding service account from the corresponding cloud service, as the cloud API authentication information.

The authentication information administration unit, in the case of a cloud service which does not allow accessing the user data through authentication of one of an administrator account and a service account, may store an OAuth access token and a refresh token issued through authentication of a user account from the corresponding cloud service, as the cloud API authentication information.

The authentication information administration unit may be periodically reissued and stores the OAuth access token using the stored refresh token.

The authentication information administration unit, when the stored OAuth access token is invalid any OAuth access token is not stored, may deactivate the corresponding user account or may set an access denial of the cloud service.

According to still another aspect of the present invention, there is provided a computer-readable recording medium in which a program for executing the cloud data discovery method of claim 1 is recorded.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates a cloud data discovery system and an enterprise cloud service environment which includes the same according to one embodiment of the present invention;

FIG. 2 is a block diagram of the cloud data discovery system according to one embodiment of the present invention;

FIG. 3 is a flowchart illustrating a method in which an authentication information administration unit obtains, stores, and administrates cloud application program interface (API) authentication information of each cloud service according to one embodiment of the present invention; and

FIG. 4 is a flowchart illustrating a process in which a user data checking unit periodically checks user data stored in cloud services according to one embodiment of the present invention.

### DETAILED DESCRIPTION

Hereinafter, exemplary embodiments of the present invention will be described in detail with reference to the drawings. Hereinafter, throughout the following description and attached drawings, like reference numerals designate like elements and a repetitive description thereof will be omitted. While describing the present invention, when it is determined that a detailed description of well-known functions or components may make the points of the present invention unclear, the detailed description will be omitted.

Combinations of respective blocks of an attached block diagram and respective steps of a flowchart may be performed by algorithms or computer program instructions, formed of firmware, software, or hardware. Since these algorithms or computer program instructions may be loaded on a processor of a general-purpose computer, a special-purpose computer, or another programmable digital signal processing device, the instructions executed through a processor of a computer or other programmable data processing device form means which perform functions described in the respective blocks of the block diagram or the respective steps of the flowchart. Since these algorithms or computer program instructions may be stored in a computer-usable or computer-readable memory which may move toward a computer or other programmable data processing device to provide a function in a particular way, the instructions stored in the computer-usable or computer-readable memory may produce goods including instruction means which perform functions described in the respective blocks of the block diagram or the respective steps of the flowchart. Since the computer program instructions may be loaded on the computer or other programmable data processing device, a series of operation steps are performed in the computer or other programmable data processing device to generate a process executed by a computer in such a way that instructions executing the computer or other programmable data processing device may provide steps for performing the functions described in the respective blocks of the block diagram or the respective steps of the flowchart.

Also, the respective blocks or the respective steps may indicate parts of modules, segments, or codes which include one or more executable instructions for executing specified logical function(s). Also, it will be understood that the functions mentioned in the blocks or steps may occur irrespective of order in several substitutable embodiments. For example, two blocks or steps sequentially illustrated may be actually performed at the same time or sometimes the blocks or steps may be performed in reverse order depending on a corresponding function.

Respective features of several embodiments of the present invention may be partially or totally coupled or combined, which will be fully understood by one of ordinary skill in the art to technically interwork and drive the same. The respective embodiments may be independently performed or performed together with others in relation in relation to one another.

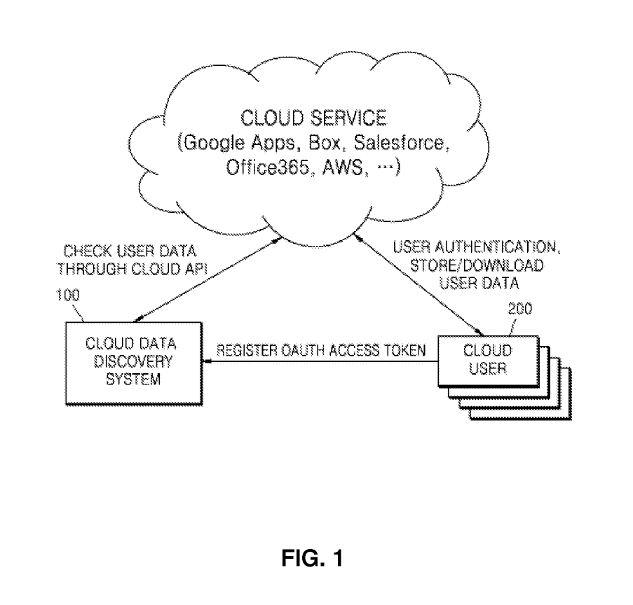

FIG. 1 illustrates a cloud data discovery system 100 and an enterprise cloud service environment which includes the same according to one embodiment of the present invention.

In the embodiments of the present invention, a company may use one or more enterprise cloud services. For example, one or more cloud services of Google Apps, Box Inc, Salesforce.Com, Office365, Amazon Web Services (AWS), etc. may be used.

A cloud user 200 may be a user (or a user terminal) included in a corresponding company, which may be a terminal inside the company or a bring your own device (BYOD) terminal such as a mobile terminal. The cloud user 200 may access a cloud service using a given user account and may store, download, or share user data with other users.

The cloud data discovery system 100 is a part of a data loss prevention (DLP) system of the company and may be formed of at least one server. The cloud data discovery system 100 accesses user data of the cloud service through a cloud application program interface (API), checks the user data according to a preset DLP policy, and stores and reports a checking result. As necessary, the cloud data discovery system 100 controls leakage of information through warning, the deletion of data, and encryption.

The cloud data discovery system 100 interworks one or more cloud services, has cloud API authentication information for each cloud service, accesses user data using cloud API authentication information corresponding to the cloud service, and checks the user data according to the DLP policy.

As for authentication and authorization systems of enterprise cloud services, there are present (i) a method of accessing user data using one of the authentication of an administrator account and an OAuth access token of the administrator account, (ii) a method of accessing user data through authentication of a service account, and (iii) a method of accessing user data only using one of a corresponding user account and an OAuth access token of the user account. For example, Google Apps and Box Inc correspond to (i) and (ii) and Salesforce.com and Office365 correspond to (iii).

The cloud data discovery system 100 has identification (ID) and a password of one of an administrator account and a service account or has an OAuth access token and a refresh token issued through authentication of one of an administrator account and a service account from the cloud service as the cloud API authentication information of a cloud service corresponding to (i) and (ii).

Also, the cloud data discover system 100 has an OAuth access token and a refresh token issued through authentication of a user account from a cloud service as cloud API authentication information of a cloud service corresponding to (iii). For this, the cloud user 200 registers the OAuth access token and the refresh token issued when the user account of the cloud service corresponding to (iii) is authenticated, in the cloud data discovery system 100.

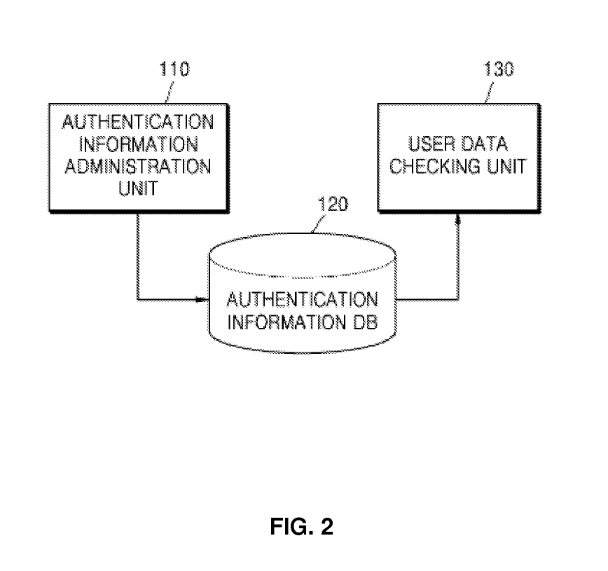

FIG. 2 is a block diagram of the cloud data discovery system 100 according to one embodiment of the present invention. The cloud data discovery system 100 may include an authentication information administration unit 110, an authentication information database 120, and a user data checking unit 130.

The authentication information administration unit 110 obtains cloud API authentication information for each cloud service and stores and administrates the cloud API authentication information.

The user data checking unit 130 accesses user data stored in the corresponding cloud service using the cloud API authentication information for each cloud service stored in the authentication information database 120, checks the user data according to a preset DLP policy, and stores and reports a checking result. As necessary, the user data checking unit 130 may perform operations such as warning, the deletion of data, and encryption.

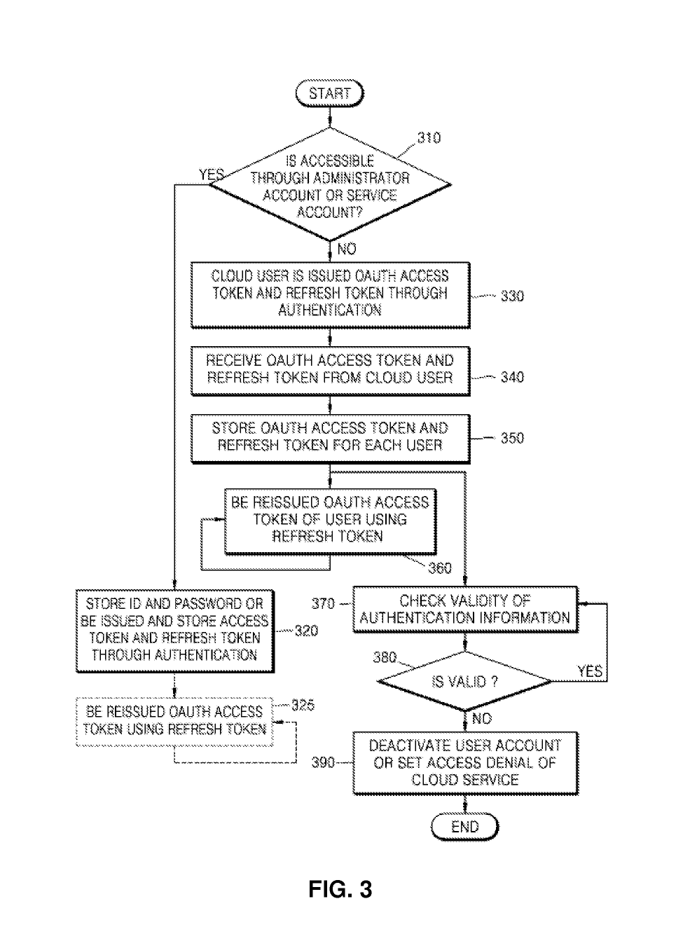

FIG. 3 is a flowchart illustrating a method in which the authentication information administration unit 110 obtains, stores, and administrates the cloud API authentication information of each cloud service according to one embodiment of the present invention.

When the cloud service allows accessing the user data using one of administrator account authentication and service account authentication in S310, the authentication information administration unit 110 stores ID and password of one of an administrator account and a service account or is issued and stores an OAuth access token and a refresh token through authentication of one of the administrator account and the service account from the corresponding cloud service, as the cloud API authentication information of the corresponding cloud service in S320.

When the OAuth access token and the refresh token are stored as the cloud API authentication information in S320, the authentication information administration unit 110 is periodically reissued the OAuth access token using the refresh token and stores the same in S325. Generally, since the OAuth access token has a very short available period, for example, one hour, the OAuth access token is periodically reissued using the refresh token whose available period is long, thereby continuously accessing the user data using the reissued OAuth access token without repetitive authentication.

When the cloud service does not allow accessing the user data using one of the administrator account authentication and service account authentication, that is, when it is possible to access the user data only using one of a corresponding user account and an OAuth access token of the user account in S310, the cloud user 200 is issued an OAuth access token and a refresh token through user account authentication from the cloud service in S330.

Then, in S340, the authentication information administration unit 110 receives the OAuth access token and the refresh token issued through the corresponding user account authentication from the cloud user 200.

Also, in S350, the authentication information administration unit 110 stores OAuth access tokens and refresh tokens for respective cloud users of the corresponding cloud service in the authentication information database 120.

In S360, the authentication information administration unit 110 is periodically reissued and stores the OAuth access tokens using the refresh tokens for respective user accounts. Generally, since the OAuth access token has a very short available period, for example, one hour, the OAuth access token is periodically reissued using the refresh token whose available period is long, thereby continuously accessing the user data using the reissued OAuth access token without repetitive authentication.

In addition, in S370, the authentication information administration unit 110 periodically checks the validity of authentication information, that is, the OAuth access tokens stored in the authentication information database 120 with respect to the respective cloud users. In S380, when the OAuth access token of the corresponding cloud user is invalid or when the OAuth access token of the corresponding cloud user is nonregistered, which occurs when the cloud user does not register the OAuth access token after user account authentication, in 390, the authentication information administration unit 110 deactivates the corresponding user account or sets a denial of accessing the cloud service with respect the corresponding user account. The setting of deactivation or access denial of the user account may be performed using a user administration API provided by the cloud service. As described above, when the cloud user does not register the OAuth access token, the corresponding user account is deactivated or set as an access denial, thereby forcing the cloud user to register the OAuth access token.

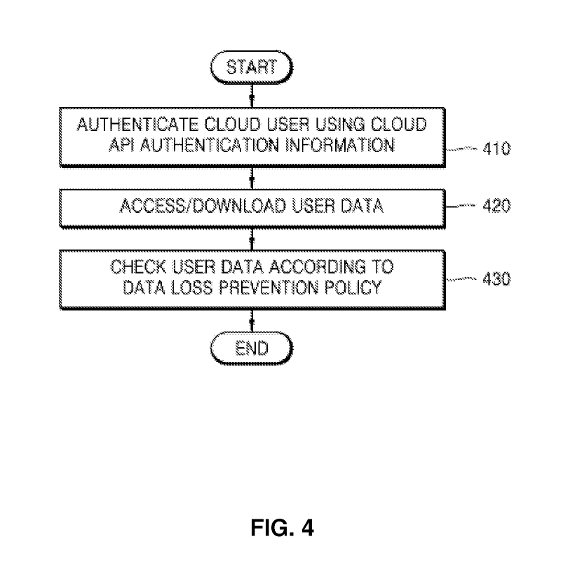

FIG. 4 is a flowchart illustrating a process in which the user data checking unit 130 periodically checks user data stored in cloud services according to one embodiment of the present invention.

In S410, the user data checking unit 130 performs cloud user authentication using cloud API authentication information stored in the authentication information database 120 for respective cloud services. That is, in the case of a cloud service in which it is possible to access user data through one of administrator account authentication and service account authentication, the authentication is performed using an OAuth access token issued through authentication of one of an administrator account and a service account. Also, in the case of a cloud service in which it is possible to access user data only using a corresponding user account and an OAuth access token of the user account, the authentication is performed using an OAuth access token issued through authentication of the corresponding user account.

In S420, the user data checking unit 130 accesses user data of a corresponding user and downloads the user data.

In S430, the user data checking unit 130 checks whether signification information such as private information and classified information is included in the downloaded user data according to a preset DLP policy and stores and reports a checking result.

With respect to the embodiments described above, the steps of the described methods or algorithms may be directly performed through hardware executed by a processor, a software module, and a combination thereof. The software module may be installed in one of a random-access memory (RAM), a flash memory, a read-only memory (ROM), an erasable programmable ROM (EPROM), an electrically EPROM (EEPROM), a register, a hard disk, a detachable disk, a compact disc ROM (CD-ROM), and storage media which have other random forms known in the art. An exemplary storage medium is coupled with a processor. The processor may read information from the storage medium and may store information in the storage medium. As another example, a storage medium may be integrated with a processor. A processor and storage medium may be installed in an application-specific integrated circuit (ASIC). An ASIC may be installed in a terminal. As another example, a processor and storage medium may be installed in a terminal as individual components.

According to the embodiment of the present invention, a DLP discover function may be effectively performed with respect to user data stored in cloud services in response to an authentication and authorization system for allowing a user of enterprise cloud services to access data.

Also, the DLP discover function may be effectively performed even in the case of enterprise cloud services in which it is possible to access user data only using one of a user account and an OAuth access token.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A cloud data discovery method comprising:
(a) storing cloud application program interface (API) authentication information for each cloud service; and
(b) accessing user data stored in a corresponding cloud service using the stored cloud API authentication information and checking the user data according to a preset data loss prevention (DLP) policy.

2. The method of claim 1, wherein the operation (a) comprises, in the case of a cloud service which allows accessing the user data through authentication of one of an administrator account and a service account, storing one of a corresponding administrator account, a corresponding service account, and an OAuth access token and a refresh token issued through the authentication of one of the corresponding administrator account and the corresponding service account from the corresponding cloud service, as the cloud API authentication information.

3. The method of claim 1, wherein the operation (a) comprises, in the case of a cloud service which does not allow accessing the user data through authentication of one of an administrator account and a service account, storing an OAuth access token and a refresh token issued through authentication of a user account from the corresponding cloud service, as the cloud API authentication information.

4. The method of claim 3, wherein the operation (a) further comprises being periodically reissued and storing the OAuth access token using the stored refresh token.

5. The method of claim 3, wherein the operation (a) further comprises, when the stored OAuth access token is invalid any OAuth access token is not stored, deactivating the corresponding user account or setting an access denial of the cloud service.

6. A cloud data discovery system comprising:
an authentication information administration unit which stores cloud API authentication information for each cloud service; and
a user data checking unit which accesses user data stored in a corresponding cloud service using the stored cloud API authentication information and checks the user data according to a preset DLP policy.

7. The system of claim 6, wherein the authentication information administration unit, in the case of a cloud service which allows accessing the user data through authentication of one of an administrator account and a service account, stores one of a corresponding administrator account, a corresponding service account, and an OAuth access token and a refresh token issued through the authentication of one of the corresponding administrator account and the corresponding service account from the corresponding cloud service, as the cloud API authentication information.

8. The system of claim 6, wherein the authentication information administration unit, in the case of a cloud service which does not allow accessing the user data through authentication of one of an administrator account and a service account, stores an OAuth access token and a refresh token issued through authentication of a user account from the corresponding cloud service, as the cloud API authentication information.

9. The system of claim 8, wherein the authentication information administration unit is periodically reissued and stores the OAuth access token using the stored refresh token.

10. The system of claim 8, wherein the authentication information administration unit, when the stored OAuth access token is invalid any OAuth access token is not stored, deactivates the corresponding user account or sets an access denial of the cloud service.

11. A computer-readable recording medium in which a program for executing the cloud data discovery method of claim 1 is recorded.
